(19) United States
(12) Patent Application Publication
(10) Pub. No.: US 2026/0147480 A1
(43) Pub. Date: May 28, 2026

(54) STORAGE CONTROLLER, STORAGE DEVICE AND STORAGE SYSTEM INCLUDING THE SAME

(71) Applicant: SAMSUNG ELECTRONICS CO., LTD., Suwon-si (KR)

(72) Inventors: Jea-Young KWON, Suwon-si (KR); Jaesub KIM, Suwon-si (KR)

(73) Assignee: SAMSUNG ELECTRONICS CO., LTD., Suwon-si (KR)

(21) Appl. No.: 19/300,369

(22) Filed: Aug. 14, 2025

(30) Foreign Application Priority Data
Nov. 22, 2024 (KR) 10-2024-0168132

(51) Int. Cl. G06F 3/06

(52) U.S. Cl. CPC G06F 3/0611; G06F 3/0659; G06F 3/0679

(57) ABSTRACT

A storage device includes a non-volatile memory device storing a first set of a map loading unit to convert a logical address into a physical address and a storage controller storing a second set of a map loading unit in a volatile memory based on the first set of the map loading unit, wherein the storage controller, based on a first command received from a host device, loads a first map loading unit corresponding to the first command of the first set from the non-volatile memory device and store the first map loading unit in the volatile memory, obtains a first logical address associated with a second command queued to a command queue of the host device, and loads a second map loading unit corresponding to the obtained first logical address from the non-volatile memory device and store the second map loading unit in the volatile memory.

### CROSS-REFERENCE TO RELATED APPLICATION

The present application claims priority to Korean Patent Application No. 10-2024-0168132, filed in the Korean Intellectual Property Office on Nov. 22, 2024, the entire contents of which are hereby incorporated by reference.

### BACKGROUND

### Field

The present disclosure relates to a storage controller, a storage device and a storage system including the same.

### Description of Related Art

Semiconductor memories are grouped into volatile memory devices such as Static RAM (SRAM), Dynamic RAM (DRAM), Synchronous DRAM (SDRAM), etc that lose stored data when power is blocked, and non-volatile memory devices such as Read Only Memory (ROM), Programmable ROM (PROM), Electrically Programmable ROM (EPROM), Electrically Erasable and Programmable ROM (EEPROM), flash memory devices, Phase-change RAM (PRAM), Magnetic RAM (MRAM), Resistive RAM (RRAM), Ferroelectric RAM (FRAM), etc. that retain stored data even when power is blocked.

### SUMMARY

The present disclosure is aimed to provide a storage controller for reducing latency that may occur due to map loading for converting a logical address to a physical address, a storage device and a storage system including the same.

The problem to be solved is not limited the above, but the other tasks not mentioned above may be explicitly known to those skilled in the art from the description of the present disclosure below.

According to embodiments of the present disclosure, there is provided a storage device including a non-volatile memory device configured to store a first set of a map loading unit to convert a logical address into a physical address, and a storage controller configured to store a second set of a map loading unit in a volatile memory based on the first set of the map loading unit, wherein the storage controller is further configured to, based on a first command received from the host device, load a first map loading unit corresponding to the first command of the first set of the map loading unit from the non-volatile memory device and store the first map loading unit in the volatile memory, obtain a first logical address associated with a second command queued to a command queue of the host device, and load a second map loading unit corresponding to the obtained first logical address of the first set of the map loading unit from the non-volatile memory device and store the second map loading unit in the volatile memory.

According to embodiments of the present disclosure, there is provided a storage controller including a host interface circuit configured to receive a first command from a host device, and obtain a first logical address associated with a second command queued to a command queue of the host device, and a second logical address associated with a third command queued to the command queue, and a flash translation layer configured to load a first map loading unit corresponding to the first command, a second map loading unit corresponding to the first logical address, and a third map loading unit corresponding to the second logical address from a non-volatile memory device and store the first map loading unit, the second map loading unit, and the third map loading unit in a volatile memory, and one or more processors, wherein the second command and the third command are commands to be processed by the one or more processors following the first command.

According to embodiments of the present disclosure, there is a provided a storage system including a host device including a host memory including a command queue, a non-volatile memory device configured to store a first set of a map loading unit for converting a logical address into a physical address, and a storage controller configured to store a second set of a map loading unit in a volatile memory based on the first set of the map loading unit, wherein the storage controller is further configured to, based on a first command received from the host device, store a first map loading unit corresponding to the first command of the first set of the map loading unit from the non-volatile memory device and store the first map loading unit in the volatile memory, obtain a logical address associated with a second command queued to a command queue of the host device, and load a second map loading unit corresponding to the logical address associated with the second command of the first set of the map loading unit from the non-volatile memory device and store the second map loading unit in the volatile memory.

According to embodiments, the latency that may occur due to map loading may be minimized by loading a map loading unit corresponding to a logical address associated with a command to a volatile memory before the command is fetched.

According to embodiments, when a map loading unit corresponding to one or more logical addresses in a logical address list is stored in a volatile memory, unnecessary overwriting may be prevented by removing the map loading unit from victim data.

According to embodiments, unnecessary resource consumption caused by reloading the map loading unit overwritten by another map loading unit into a volatile memory may be minimized by determining the map loading unit with the lowest reference count as victim data.

According to embodiments, unnecessary resource consumption required to operate a flush operation before overwriting victim data may be minimized by determining victim data based on information associated with at least one map loading unit to perform a flush operation.

The effect that is obtained from the present disclosure is not limited to the above. The technical effect not mentioned above may be explicitly known to those skilled in the art from the description below.

### BRIEF DESCRIPTION OF DRAWINGS

FIG. 1 is a view illustrating a storage system according to embodiments of the present disclosure;

FIG. 2 is a view illustrated to explain a non-volatile memory according to embodiments of the present disclosure;

FIG. 3 is a perspective view illustrating a memory block according to embodiments of the present disclosure;

FIG. 4 is a circuit view illustrating a memory block according to embodiments of the present disclosure;

FIG. 5A is a view illustrating detail configurations of a storage system according to an embodiment of the present disclosure;

FIG. 5B is a view illustrating detail configurations of a storage system according to another embodiment;

FIG. 6 is a flowchart illustrating an operation method of a storage system according to embodiments of the present disclosure;

FIG. 7A is a view illustrated to explain step S610 of FIG. 6 according to an embodiment of the present disclosure;

FIG. 7B is a view illustrated to explain step S610 of FIG. 6 according to another embodiment of the present disclosure;

FIG. 8 is a view illustrated to explain steps S620 and S630 of FIG. 6 according to embodiments of the present disclosure;

FIG. 9 is a flowchart illustrated to explain step S630 of FIG. 6 in detail according to embodiments of the present disclosure;

FIG. 10A and FIG. 10B are views illustrated to explain a process in which victim data is determined and overwritten;

FIG. 11 is a view illustrated to explain steps S640 and step S650 of FIG. 6 according to embodiments of the present disclosure;

FIG. 12 is a view illustrated to explain step S660 of FIG. 6 according to embodiments of the present disclosure; and

FIG. 13 is a view illustrated to explain step S670 of FIG. 6 according to embodiments of the present disclosure.

### DETAILED DESCRIPTION

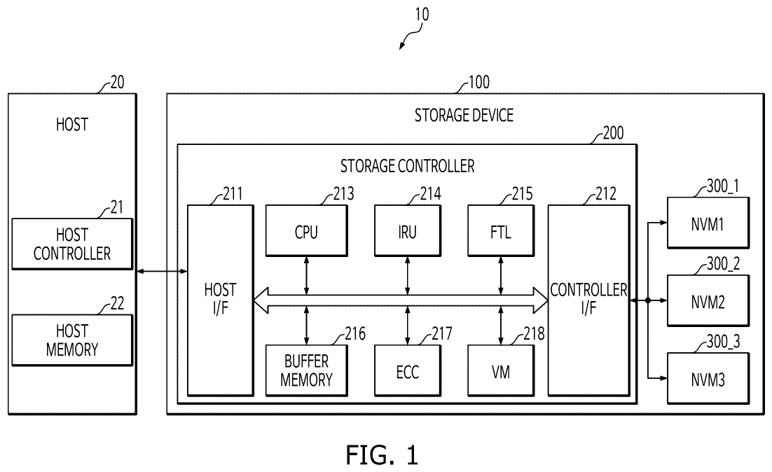

Embodiments of the technical spirit of the present disclosure will be described in detail with reference to FIG. 1 to FIG. 13. Like reference numerals in the drawings denote like elements, and the redundant description will be omitted.

FIG. 1 is a view illustrating a storage system 10 according to embodiments of the present disclosure. Referring to FIG. 1, the storage system 10 may include a host device 20 and a storage device 100. The host device 20 and the storage device 100 may transmit and receive data and/or signals to each other.

The host device 20 may include a host controller 21 and a host memory 22. The host memory 22 may function as a buffer memory for temporarily storing data to be transmitted to the storage device 100, or data transmitted from the storage device 100.

According to embodiments, the host controller 21 and the host memory 22 may be implemented as separate semiconductor chips. Alternatively, the host controller 21 and the host memory 22 may be integrated into the same semiconductor chip. For example, the host controller 21 may be one of a plurality of modules provided in an application processor, and the application processor may be implemented as system on chip (SoC). The host memory 22 may be an embedded memory provided in the application processor, or a volatile memory or a memory module placed outside the application processor.

According to embodiments, the host controller 21 may manage to store data of the host memory 22 in non-volatile memory devices 300_1, 300_2 and 300_3 through the storage controller 200, or store data of the non-volatile memory devices 300_1, 300_2 and 300_3 in the host memory 22 through the storage controller 200.

The storage device 100 may include the storage controller 200 and a plurality of non-volatile memory devices (NVMs) 300_1, 300_2 and 300_3. The storage controller 200 and each of the plurality of nonvolatile memory devices 300_1, 300_2 and 300_3 may transmit and receive data or signals, etc., to each other. Although three (3) non-volatile memory devices 300_1, 300_2 and 300_3 are illustrated in FIG. 1, the present disclosure is not limited thereto, and any number of memory devices may be included in the storage device 100. For example, the storage device 100 may include a plurality of memory devices connected and arranged in an array form.

The storage device 100 may include a storage medium for storing data upon a request from the host device 20. For example, the storage device 100 may include at least one of a Solid state drive (SSD), an embedded memory and a removable external memory. When the storage device 100 is the SSD, the storage device 100 may be a device according to the non-volatile memory express (NVMe) standard. When the storage device 100 is an embedded memory or an external memory, the storage device 100 may be a device that follows the universal flash storage (UFS) standard or the embedded multi-media card (eMMC) standard. The host device 20 and the storage device 100 each may generate and transmit packets according to the adopted standard protocol.

When the non-volatile memory devices 300_1, 300_2 and 300_3 include a flash memory, the flash memory may include a 2D NAND memory array or a 3D (or vertical, or bonding vertical) NAND (VNAND) memory array. For another example, the storage device 100 may also include other various types of non-volatile memories and/or volatile memories. For example, the storage device 100 may include at least one of volatile memories or non-volatile memories, such as static RAM (SRAM), dynamic RAM (DRAM), synchronous DRAM (SDRAM), read-only memory (ROM), programmable ROM (PROM), electrically programmable ROM (EPROM), electrically erasable and programmable ROM (EEPROM), magnetic RAM (MRAM), spin-transfer torque MRAM, conductive bridging RAM (CBRAM), ferroelectric RAM (FeRAM), phase RAM (PRAM), and resistive RAM. At least a part of the plurality of non-volatile memory devices 300_1, 300_2 and 300_3 may be alternatively volatile memory devices.

The storage controller 200 may include a host interface 211, a controller interface circuit 212 and a central processing unit (CPU) 213. The storage controller 200 may further include an index read unit (IRU) 214, a flash translation layer (FTL) 215, a buffer memory 216, an error correction code (ECC) engine 217, and an internal volatile memory 218. The storage controller 200 may further include a working memory into which the flash translation layer 215 is loaded, and control data writing and reading operations for the non-volatile memory may be controlled by the CPU 213 executing the flash translation layer 215.

The host interface 211 may transmit and receive a packet to and from the host device 20. The packet transmitted from the host device 20 to the host interface 211 may include commands and/or data to be written or transmitted to the non-volatile memory devices 300_1, 300_2 and 300_3, and the packet transmitted from the host interface 211 to the host device 20 may include a response to the command, or data read from the non-volatile memory devices 300_1, 300_2 and 300_3, etc. It is illustrated that the host interface 211 is included in the storage controller 200, but the present disclosure is not limited thereto. For example, the host interface 211 may be placed outside the storage controller 200.

The controller interface circuit 212 may transmit data to be written in the non-volatile memory devices 300_1, 300_2 and 300_3 to the non-volatile memory devices 300_1, 300_2 and 300_3 or receive data read from the non-volatile memory devices 300_1, 300_2 and 300_3. The controller interface circuit 212 may be implemented to comply with standard protocols such as toggle or ONFI.

The flash translation layer 215 may perform various functions such as address mapping, wear-leveling, garbage collection, etc. For example, the flash translation layer 215 may obtain a physical address corresponding to a logical address from the logical address. The buffer memory 216 may temporarily store the data to be written on the memory devices 300_1, 300_2 and 300_3 or the data read from the non-volatile memory devices 300_1, 300_2 and 300_3. The buffer memory 216 may be included in the storage controller 200, or placed outside the storage controller 200.

The ECC engine 217 may perform error detection or correction on read data read from the non-volatile memory devices 300_1, 300_2 and 300_3. The ECC engine 217 may generate a parity bit for write data to be written to the non-volatile memory devices 300_1, 300_2 and 300_3, and the generated parity bit may be stored in the non-volatile memory devices 300_1, 300_2 and 300_3 along with the write data. When data is read from the non-volatile memory devices 300_1, 300_2 and 300_3, the ECC engine 217 may correct errors in the read data by using the parity bit read from the non-volatile memory devices 300_1, 300_2 and 300_3 alongside the read data, and output the read data with errors corrected.

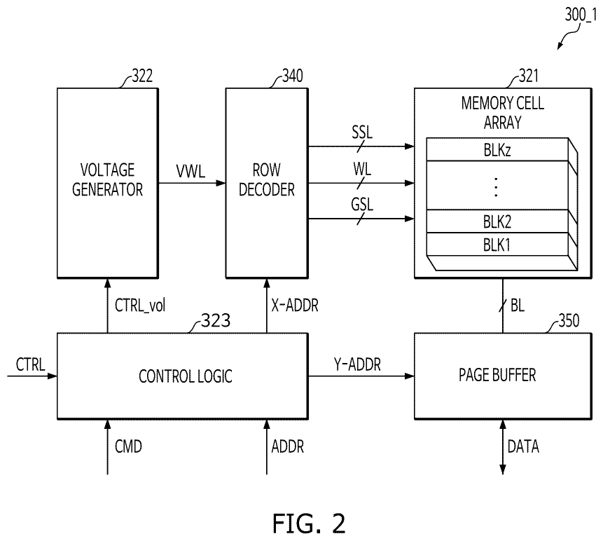

FIG. 2 is a view illustrated to explain a non-volatile memory according to embodiments of the present disclosure. It is illustrated and explained that each element of FIG. 2 is included in one non-volatile memory device 300_1 of FIG. 1, but it should be understood that embodiments described with reference to FIG. 2 are applied to any non-volatile memory device connected to the storage controller 200 of FIG. 1.

Referring to FIG. 2, a non-volatile memory device 300_1 may include a memory cell array 321, a voltage generator 322, a control logic circuit 323, a row decoder 340, and a page buffer circuit 350. According to another embodiment, the non-volatile memory device 300_1 may further include a data input and output circuit or an input and output interface.

The memory cell array 321 may include a plurality of memory cells, and may be connected to word lines WL, string selection lines SSL, ground selection lines GSL, and a plurality of bit lines BL. The memory cell array 321 may be connected to the row decoder 340 through the word lines WL, the string selection lines SSL, and the ground selection lines, and may be connected to the page buffer circuit 350 through the plurality of bit lines BL.

The memory cell array 321 may include a plurality of memory blocks BLK1 to BLKz. Each of the plurality of memory blocks BLK1 to BLKz may include a plurality of pages connected to memory cells. Each of the word lines WL may be connected to one or more pages.

Each of the plurality of memory blocks BLK1 to BLKz may include a three (3)-dimensional structure (a vertical structure). Each memory block may include structures extending along first to third directions. For example, each memory block may include a plurality of NAND strings extending along the third direction. The plurality of NAND strings may be spaced apart by a specific distance along the first and second directions.

The plurality of memory blocks BLK1 to BLKz may be selected by the row decoder 340. For example, the row decoder 340 may select a memory block corresponding to a block address among the plurality of memory blocks BLK1 to BLKz.

Each of the plurality of memory blocks BLK1 to BLKz may correspond to a specific logic block accessed by a storage controller (e.g., 200 of FIG. 1). For example, one logic block may correspond to at least one physical memory block among the plurality of memory blocks BLK1 to BLKz. The flash translation layer (e.g., 215 of FIG. 1) of the storage controller may manage the mapping relationship between the logic blocks and the plurality of memory blocks BLK1 to BLKz, and access the plurality of memory blocks BLK1 to BLKz by using the logic blocks.

Each of the memory cells included in the memory cell array 321 may include at least one or more bits. According to embodiments, the memory cell may be a single-level cell SLC that stores one (1) bit of data. The memory cell may be a multi-level cell (MLC), or a double-level cell that stores two (2) bits of data, a triple-level cell (TLC) that stores three (3) bits of data, or a quadruple-level cell (QLC) that stores four (4) bits of data. However, the present disclosure is not limited thereto.

When an erase voltage is applied to the memory cell array 321, the plurality of memory cells may be erased, and when a program voltage is applied to the memory cell array 321, the plurality of memory cells may be programmed. Each memory cell may have an erase state or at least one program state distinguished according to a threshold voltage. The states of the memory cells may include an erase state or at least one program state, and the specific state of each memory cell may be one of the erase state or at least one program state.

The control logic circuit 323 may control the various operations in the non-volatile memory device 300_1. For example, the control logic circuit 323 may output various control signals to write or read data to or from the memory cell array 321 based on a command CMD, an address ADDR, and a control signal CTRL. The control logic circuit 323 may control a plurality of program operations to be performed on a plurality of pages.

Various control signals output from the control logic circuit 323 may be provided to a voltage generator 322, a row decoder 340, and a page buffer circuit 350. For example, the control logic circuit 323 may provide a voltage control signal CTRL_vol to the voltage generator 322.

The voltage generator 322 may be connected to the memory cell array 321 through the plurality of word lines WL. The voltage generator 322 may generate various types of voltages for performing a program operation, a read operation and/or an erase operation on the memory cell array 321 based on the voltage control signal CTRL_vol. The voltage generator 322 may generate word line voltages VWL, for example, a program voltage, a verification voltage, a read voltage, an erase voltage, etc.

The program voltage, the verification voltage, the read voltage, the erase voltage, etc. generated by the voltage generator 322 may be provided to a selected word line among the plurality of word lines WL. The selected word line may be at least one word line selected by a row address X-ADDR. Each of the plurality of word lines WL may include a plurality of pages, and the program operation, the verification operation, the read operation, the erase operation, etc., controlled by the voltages generated by the voltage generator 322 may be performed in units of pages. For example, the program operation and the verification operation on the selected page may be performed by applying a program voltage (e.g., a pulse) and a verification voltage (e.g., a pulse) to a selected page in a selected word line.

During the erase operation, the voltage generator 322 may apply an erase voltage to a well and/or a common source line of a memory block. The voltage generator 322 may apply an erase allowance voltage (e.g., a ground voltage) to all of the word lines WL or the word lines corresponding to a part of sub-blocks based on an erase address. During the erase verification operation, the voltage generator 322 may apply an erase verification voltage to all of the word lines WL of one memory block, or apply an erase verification voltage on a word line basis.

During the program operation, the voltage generator 322 may apply a program voltage to a selected word line among the plurality of word lines WL, and apply a program pass voltage to non-selected word lines among the plurality of word lines WL. During the program verification operation, the voltage generator 322 may apply a program verification voltage to the selected word line, and a verification pass voltage to the non-selected word lines.

During a normal read operation, the voltage generator 322 may apply a read voltage to the selected word lines, and apply a read pass voltage to the non-selected word lines.

During a data restoration read operation, the voltage generator 322 may apply a read pass voltage to a selected word line, and apply a read voltage to at least one word line adjacent to the selected word line. The voltage generator 322 may apply a read voltage to the selected word line, and apply a read voltage to at least one word line adjacent to the selected word line.

The row decoder 340 may select a specific word line among the word lines WL in response to a row address X-ADDR received from the control logic circuit 323. During the program operation, the row decoder 340 may provide a program voltage to the selected word line. The row decoder 340 may select a part of the string selection lines SSL, or a part of the ground selection lines GSL in response to the row address X-ADDR received from the control logic circuit 323.

The page buffer circuit 350 may be connected to the memory cell array 321 through the plurality of bit lines BL. The page buffer circuit 350 may select a part of the plurality of bit lines BL in response to a column address Y-ADDR received from the control logic circuit 323. During the verification operation (e.g., an erase verification operation or a program verification operation) or the read operation, the page buffer circuit 350 may sense the data stored in the memory cell selected by operating a sense amplifier through the selected bit line. During the program operation, the page buffer circuit 350 may input the data to be stored in the memory cell array 321 by operating a write driver. The page buffer circuit 350 may include a plurality of page buffers. Each of the plurality of page buffers may be connected to at least one bit line.

The page buffer circuit 350 may store the data read from the memory cell array 321, or store the data to be stored in the memory cell array 321.

The page buffer circuit 350 may include a plurality of page buffers respectively connected to the plurality of bit lines BL. The plurality of page buffers may respectively correspond to the plurality of bit lines, and each of the plurality of page buffers may include a plurality of latches. The page buffer circuit 350 may be defined as including a page buffer connected to each of the plurality of bit lines. However, according to embodiments, the terms may be defined differently. For example, a page buffer unit may be defined as a unit in which one page buffer is provided corresponding to a plurality of bit lines and arranged to correspond to each of the plurality of bit lines. The page buffer circuit 350 may temporarily store data to be programmed into the selected page during the program operation, and temporarily store the data read from the selected page during the read operation.

The control logic circuit 323, the voltage generator 322, the row decoder 340, and the page buffer circuit 350 may be included in a peripheral circuit.

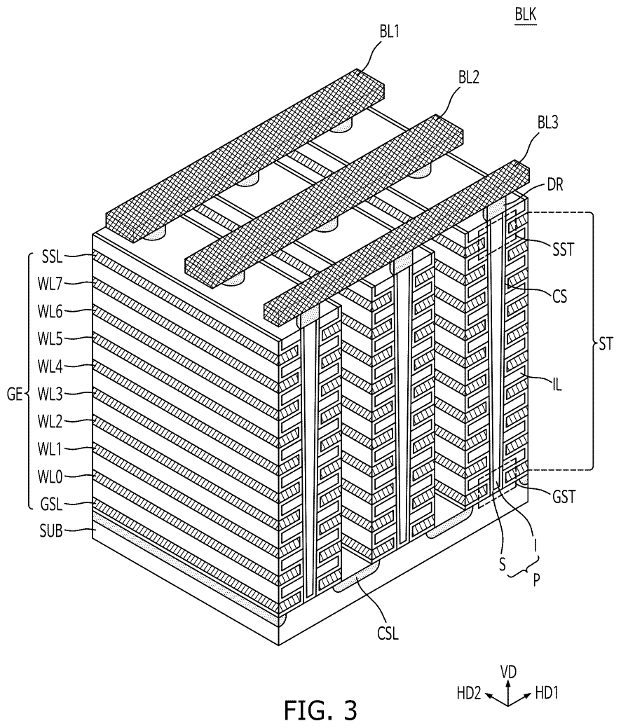

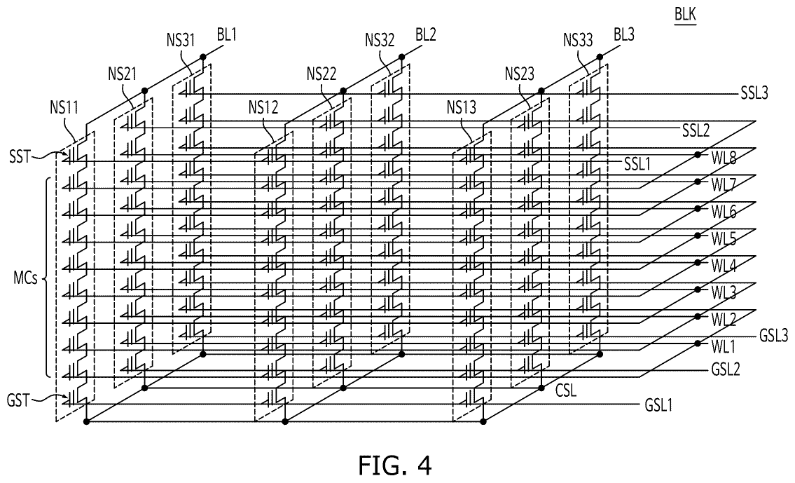

FIG. 3 is a perspective view illustrating a memory block according to embodiments of the present disclosure, and FIG. 4 is a circuit view illustrating a memory block according to embodiments of the present disclosure.

Referring to FIG. 3, a memory block BLK may include a stack ST extending in a vertical direction VD on the top of a substrate SUB. For example, the memory block BLK may include a single stack ST between the substrate SUB and bit lines BL1, BL2 and BL3.

A common source line CSL may be disposed on the substrate SUB, and insulating layers IL extending along a second horizontal direction HD2 may be sequentially provided along the vertical direction VD on the area of the substrate SUB between the two adjacent common source lines CSL, and the insulating layers IL may be spaced apart from each other by a specific distance along the vertical direction VD. Pillars P penetrating the insulating layers IL along the vertical direction VD may be provided on the area of the substrate SUB between the two adjacent common source lines CSL. The pillar may be referred to as a channel hole. The pillars P may have a cup shape (or a cylindrical shape with a closed bottom) extending in the vertical direction VD. A surface layer S of each of the pillars P may include a silicon material having a first type, and may function as a channel area. An internal layer I of each pillar P may include an insulating material such as silicon oxide, or an air gap.

A charge storage layer CS may be provided along the exposed surface of the insulating layers IL, the pillars P and the substrate SUB in the area between the two adjacent common source lines CSL. The charge storage layer CS may include a gate insulating layer, a charge trap layer, and a blocking insulating layer. For example, the charge storage layer CS may have an oxide-nitride-oxide (ONO) structure. Gate electrodes GE such as the selection lines GSL and SSL, and the word lines WL1, WL2, WL3, WL4, WL5, WL6, WL7 and WL8 may be provided on the exposed surface of the charge storage layer CS in the area between the two adjacent common source lines CSL. Drains DR may be respectively provided on the plurality of pillars P. The bit lines BL1, BL2 and BL3 extending along a first horizontal direction HD1 and spaced apart along the second horizontal direction HD2 by a specific distance may be provided on the drains DR.

Referring to FIG. 4, a memory block BLK may include a plurality of NAND strings NS11 to NS33, and each of the plurality of NAND strings (e.g., NS11) may include a string selection transistor SST, a plurality of memory cells MCs, and a ground selection transistor GST connected in series. The transistors SST and GST and memory cells MCs included in each of the NAND strings may be stacked along the vertical direction on the substrate.

The bit lines BL1, BL2 and BL3 may extend along a first direction, and the word lines WL1, WL2, WL3, WL4, WL5, WL6, WL7 and WL8 may extend along a second direction. The NAND strings NS11, NS21 and NS31 may be placed between a first bit line BL1 and the common source line CSL, the NAND strings NS12, NS22 and NS32 may be placed between a second bit line BL2 and the common source line CSL, and the NAND strings NS13, NS23 and NS33 may be placed between a third bit line BL3 and the common source line CSL.

The string selection transistor SST may be connected to corresponding string selection lines SSL1, SSL2 and SSL3. The memory cells MCs may be connected to the corresponding word lines WL1, WL2, WL3, WL4, WL5, WL6, WL7 and WL8, respectively. The ground selection transistor GST may be connected to corresponding ground selection lines GSL1, GSL2 and GSL3. The string selection transistor SST may be connected to the corresponding bit line, and the ground selection transistor GST may be connected to the common source line CSL. The number of NAND strings, the number of word lines, the number of bit lines, the number of ground selection lines, and the number of string selection lines may vary depending on embodiments.

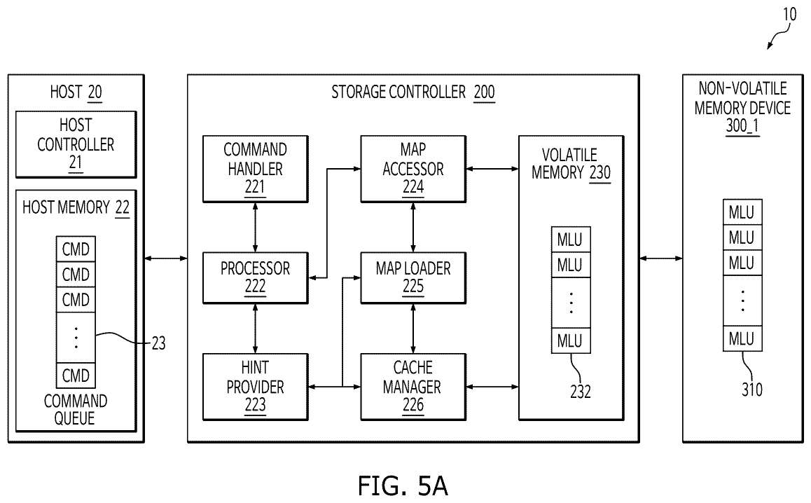

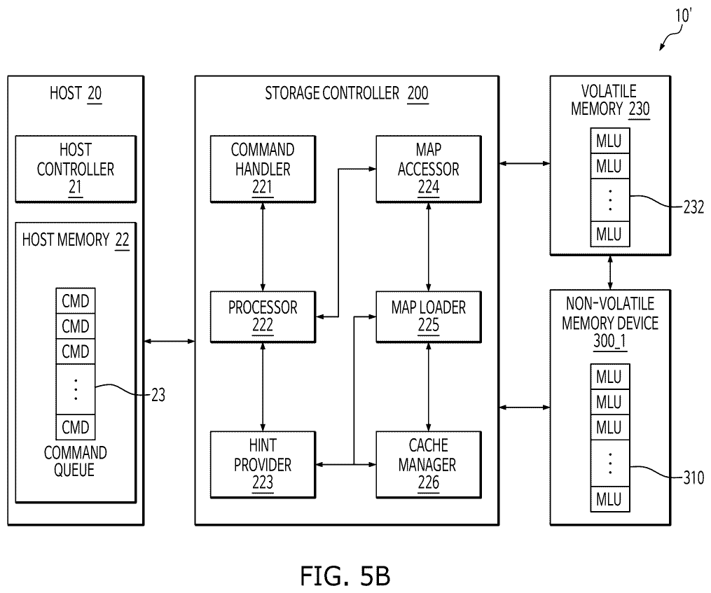

FIG. 5A is a view illustrating the detailed configuration of a storage system 10 according to an embodiment of the present disclosure, and FIG. 5B is a view illustrating the detailed configuration of a storage system 10′according to another embodiment. The arrows in FIG. 5A and FIG. 5B are exemplary, and each element of the storage controller 200 may transmit and receive data or signals with one another.

A host memory 22 may include a command queue 23. The host memory 22 may store and manage various types of commands in the form of the command queue 23. At least part of the commands stored in the command queue 23 may be a read command, a write command or a TRIM command, but the present disclosure is not limited thereto.

The command queue 23 included in the host memory 22 may be implemented as various types including a single queue, a multi-queue including a plurality of queues, a priority queue, a circular queue, etc, and the examples thereof are not limited. The command queue 23 of the host memory 22 may be located in a shared memory area accessible by the storage device 100.

The host controller 21 may queue commands to be executed or processed by the storage device 100 in the command queue 23 of the host memory 22. The host controller 21 may notify the storage controller 200 that a new command is added to the command queue 23. For example, the host controller 21 may notice the storage controller 200 that a new command is added to the command queue 23 by transmitting an interruption signal, etc., to the storage controller 200.

The host controller 21 may perform re-ordering on the commands stored in the command queue 23. For example, the order in which the commands stored in the command queue 23 are executed or processed may be different from the order in which the commands are stored in the command queue 23.

The non-volatile memory device 300_1 may store a first set of map loading units 310 for converting a logical address into a physical address. In a similar manner, the volatile memory 230 may store a second set of map loading units 232 for converting a logical address to the physical address. The second set of the map loading units 232 stored in the volatile memory 230 may be loaded or stored by the storage controller 200.

The storage controller 200 may load at least a part of the first set of the map loading units 310 (e.g., at least one or more map loading units among the first set of the map loading units 310) from the non-volatile memory device 300_1 and store or load the at least a part of the first set of the map loading units 310 in the volatile memory 230 based on the logical address related to the command received from the host device 20 or the command queued in the command queue.

According to an embodiment, the storage controller 200 may receive at least part of the first set of map loading unit 310 from the non-volatile memory device 300_1, and load or store the at least part of the received first set of the map loading unit 310 in the volatile memory 230. According to another example, the storage controller 200 may request the non-volatile memory device 300_1 to load or store at least part of the first set of map loading unit 310 in the volatile memory 230, and the non-volatile memory device 300_1 may load or store at least part of the first set of map loading unit 310 in the volatile memory 230 in response to the request from the storage controller 200.

Each of the first set of map loading unit 310 and the second set of map loading units 232 may include a plurality of map loading units. The map loading unit may include a corresponding relationship between a logical address used to access the non-volatile memory device 300_1 in the storage controller 200, and a physical address of the non-volatile memory device 300_1 corresponding to the logical address. For example, the map loading unit may include a plurality of logical addresses and a plurality of physical addresses corresponding to the plurality of logical addresses. The size of the map loading unit, or the number of logical addresses included in the map loading unit may be set arbitrarily.

The first set of map loading unit 310 may include a plurality of logical addresses in the number corresponding to the total number of logic blocks, and a plurality of physical addresses corresponding thereto. A logic block may be a logical block used as a basic unit of data input and output, for example, a minimum addressable unit used by an operating system or a file system for managing a storage space or reading or writing data. The first set of the map loading unit 310 may include all the logical addresses to be used to access the non-volatile memory device 300_1, and the physical addresses corresponding to the logical addresses.

The first set of map loading units 310 may include the second set of map loading units 232. The size of the second set of map loading unit 232 may be smaller than that of the first set of map loading units 310. A specific map loading unit corresponding to the logical address used by the storage controller 200 to access the non-volatile memory device 300_1 may not be loaded into the volatile memory 230 depending on the situation. Therefore, in order to solve the above-described problems, various embodiments of pre-loading the map loading unit corresponding to the logical address to be referenced during the processing of the command to be fetched will be detailed below.

The storage controller 200 may include a command handler 221, a processor 222, a hint provider 223, a map accessor 224, a map loader 225, and a cache manager 226.

Referring to FIG. 5A, the storage controller 200 of the storage system 10 may further include the volatile memory 230. The volatile memory 230 may correspond to an internal volatile memory 218 of FIG. 1. Referring to FIG. 5B, the volatile memory 230 of the storage system 10′ may be connected to the storage controller 200 and the non-volatile memory device 300_1 outside the storage controller 200. According to embodiments, the volatile memory 230 may be DRAM.

According to embodiments, the command handler 221 and the hint provider 223 may be included in a host interface circuit (e.g., 211 of FIG. 1) of the storage controller 200. According to embodiments, the map accessor 224, the map loader 225 and the cache manager 226 may be included in a flash translation layer (e.g., 215 of FIG. 1). According to embodiments, the processor 222 may correspond to a CPU 213 of FIG. 1. The processor 222 may include one or more processors.

The command handler 221, the processor 222, the hint provider 223, the map accessor 224, the map loader 225, and the cache manager 226 may include a processing circuit or be implemented as a processing circuit. The processing circuit may include a combination of hardware/software, such as hardware including a logic circuit, a processor executing software, or a combination thereof. For example, the processing circuit may include a central processing unit (CPU), an arithmetic logic unit (ALU), a digital signal processor (DSP), a microcomputer, a field-programmable gate array (FPGA), a system on chip (SoC), a programmable logic device (PLD), a microprocessor, an application-specific integrated circuit (ASIC), etc., but the present disclosure is not limited thereto.

The command handler 221 may receive signals from the host controller 21, or access the command queue 23 on a regular basis to identify whether a new command is stored in the command queue 23.

The command handler 221 may fetch the command queued to the command queue 23. The command handler 221 may sequentially fetch the commands in the order in which the commands are queued. Additionally or alternatively, the command handler 221 may fetch the commands based on the priority of the commands queued in the command queue 23.

The command handler 221 may fetch the commands to obtain information required for the storage controller 200 and/or the non-volatile memory device 300_1 to perform a specific operation associated with the commands, such as an opcode related to the commands, a command identifier CID, a logic block address (LBA), the number of logic blocks (NLB), a start logic block address (SLBA), a data length, flags and options, a priority level, an error checking code, etc.

The command handler 221 may transmit the fetched command to the processor 222. For example, the command handler 221 may transmit at least part of the information required for performing a specific operation related to the commands to the processor 222.

The processor 222 may process the command received from the command handler 221. For example, the processor 222 may perform a read operation, a write operation or a page copy operation. The processor 222 may be implemented in hardware and/or software.

The processor 222 may obtain the logical address of the non-volatile memory device 300_1 related to the command. The processor 222 may transmit the obtained logical address to the map accessor 224. The processor 222 may request a physical address corresponding to the obtained logical address to the map accessor 224.

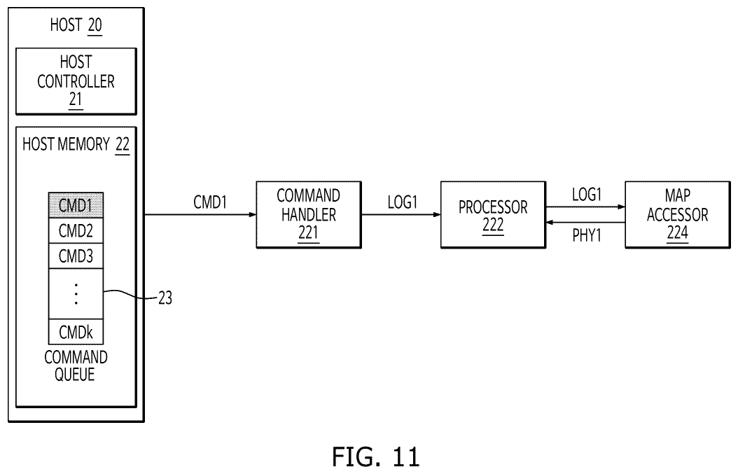

The operations of the command handler 221, the processor 222 and the map accessor 224 will be detailed below with reference to FIG. 11.

The hint provider 223 may peek at the command queued in the command queue 23. For example, when the command handler 221 fetches a previous command or the processor 222 processes a previous command, the hint provider 223 may obtain part of the information about the command queued in the command queue 23. The hint provider 223 may obtain the logical address related to the command, for example, logical address corresponding to the physical address of the non-volatile memory device 300_1 to be accessed during the processing of the command. The hint provider 223 may obtain the start logic block address related to the command and the number of logic blocks. The storage controller 200 may access the consecutive logic blocks, and perform a read operation and/or a write operation on the plurality of logic blocks starting from the start logic block address because the hint provider 223 obtains the start logic block address and the number of logic blocks. The hint provider 223 may obtain a command code (opcode) and a command identifier (CID) associated with the command.

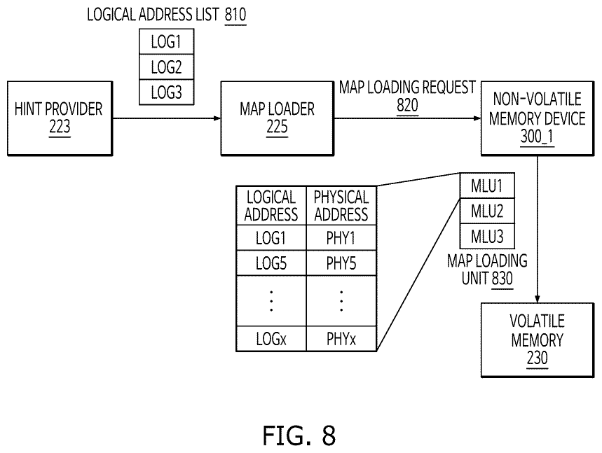

The hint provider 223 may transmit the obtained information to the map loader 225 and the cache manager 226. The hint provider 223 may transmit a request to the map loader 225 to load a map loading unit corresponding to the obtained information to the volatile memory 230. The hint provider 223 may transmit a request to the cache manager 226 to determine victim data to overwrite the obtained map loading unit. The description thereof will be detailed with reference to FIG. 8 to FIG. 10B.

The map accessor 224 may access the volatile memory 230 and obtain a map loading unit. For example, the map accessor 224 may obtain a part of the second set of map loading unit 232 loaded in the volatile memory 230 from the volatile memory 230. The map accessor 224 may obtain the map loading unit upon request from at least one processor 222, etc.

The map accessor 224 may request the map loading unit corresponding to the logical address received from the processor 222 to the volatile memory 230. The map accessor 224, when the map loading unit corresponding to the received logical address is loaded to the volatile memory 230, may obtain the corresponding map loading unit, and determine the physical address of the non-volatile memory device 300_1 corresponding to the logical address from the obtained map loading unit. The map accessor 224 may transmit the determined physical address to the processor 222, and the processor 222 may process the command by using the received physical address.

The map accessor 224, when the map loading unit corresponding to the received logical address is not loaded to the volatile memory 230, may request the map loader 225 to load the map loading unit corresponding to the received logical address to the volatile memory 230.

The map loader 225, in response to the request from the map accessor 224, may transmit a loading request to the non-volatile memory device 300_1. In response to the map loader 225 transmitting a loading request to the non-volatile memory device 300_1, at least one map loading unit stored in the non-volatile memory device 300_1 may be loaded to the volatile memory 230. A hazard may occur, such as the execution of the command being deferred for the loading time during which the map loading unit is loaded from the non-volatile memory device 300_1 to the volatile memory 230, or latency may occur due to the loading of the map loading unit.

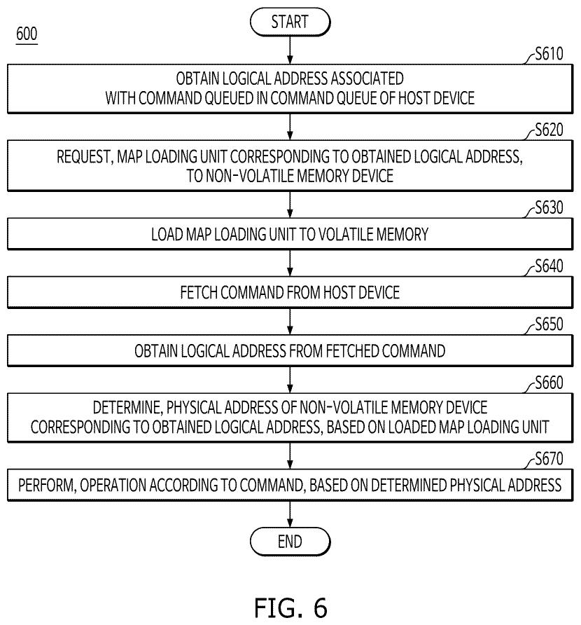

The map loader 225 may transmit a loading request to the non-volatile memory device 300_1 in response to the request from the hint provider 223. When the map loading unit corresponding to the logical address received upon the request of the processor 222 is not loaded in the volatile memory 230, the latency that occurs for loading the map loading unit to the volatile memory 230 may be reduced. The description thereof will be detailed with reference to FIG. 6 to FIG. 8.

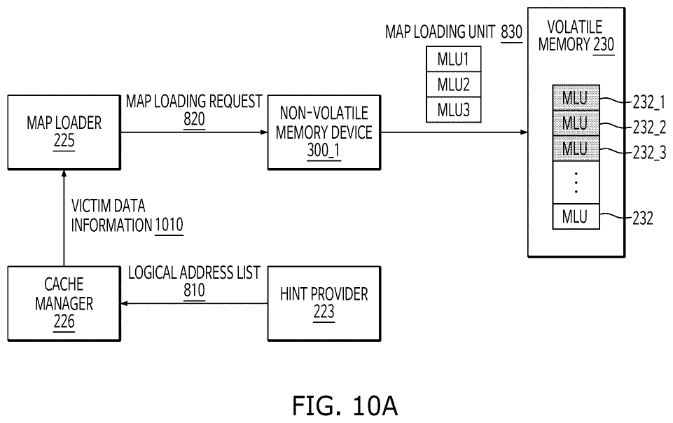

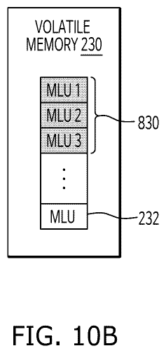

The cache manager 226 may determine the location to load or store a map loading unit in the volatile memory 230. For example, the cache manager 226 may determine victim data among the second set of the map loading unit 232 of the volatile memory 230. The cache manager 226 may transmit the determined location in the volatile memory 230 to the map loader 225. The map loader 225, in response to receiving the location in the volatile memory 230 from the cache memory 226, may control the non-volatile memory device 300_1 to store (or overwrite) the map loading unit received from the non-volatile memory device 300_1 in the received location, or store (or overwrite) the map loading unit in the received location. The description thereof will be detailed with reference to FIG. 10A and FIG. 10B.

According to embodiments, the non-volatile memory device 300_1 of FIG. 5A may transmit a map loading unit corresponding to a specific logical address of the first set of the map loading unit 310 to the storage controller 200 in response to the request from the storage controller 200, and the storage controller 200 may load or store the map loading unit received from the non-volatile memory device 300_1 to the volatile memory 230.

According to embodiments, the non-volatile memory device 300_1 of FIG. 5B may load or store the map loading unit corresponding to a specific logical address of the first set of map loading unit 310 in the volatile memory 230 in response to the request from the storage controller 200.

FIG. 6 is a flowchart illustrating an operation method 600 of a storage system according to embodiments of the present disclosure. The operation method 600 of the storage system may be performed by a storage system 10 of FIG. 5A or a storage system 10′of FIG. 5B.

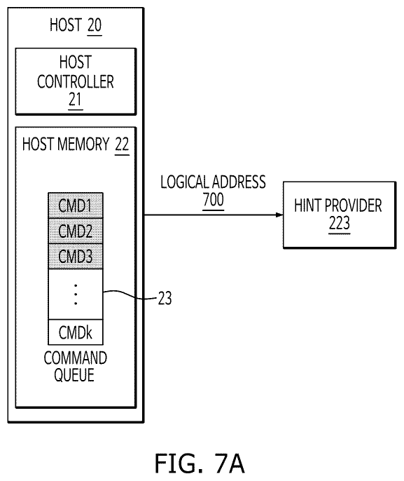

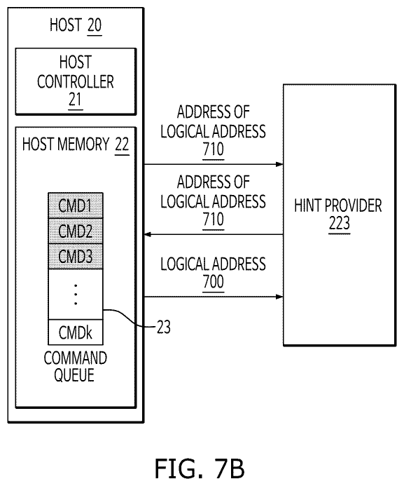

Referring to FIGS. 5A, 5B and 6, the storage controller 200 may obtain a logical address associated with the command queued to a command queue of a host device in step S610. The description thereof will be detailed below with reference to FIG. 7A and FIG. 7B.

In step S620, the storage controller 200 may request a map loading unit corresponding to the logical address obtained in step S610 to the non-volatile memory device 300_1. The description thereof will be detailed with reference to FIG. 8.

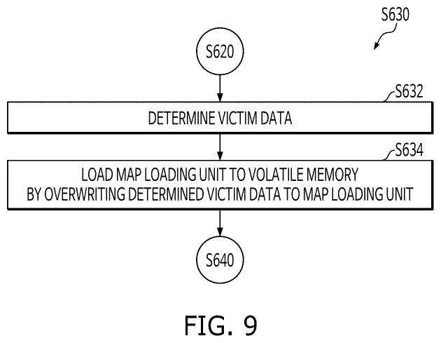

In step S630, the non-volatile memory device 300_1 and/or the storage controller 200 may load or store the map loading unit in the volatile memory 230 in response to the request in step S620. The description thereof will be detailed with reference to FIG. 9, FIG. 10A and FIG. 10B.

The storage controller 200 may fetch the command queued to the command queue 23 of the host device 20 from the host device 20 in step S640. In step S650, the storage controller 200 may obtain a logical address from the command fetched in step S650. The description thereof will be detailed with reference to FIG. 11.

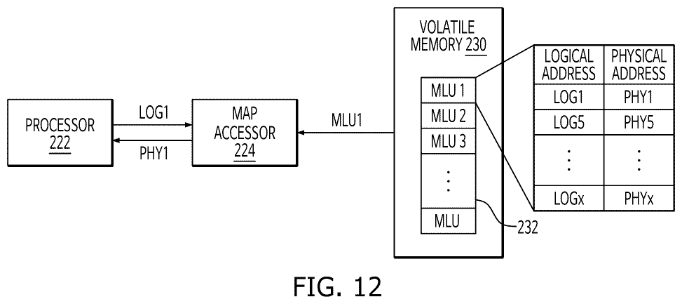

In step S660, the storage controller 200 may determine a physical address of the non-volatile memory device 300_1 corresponding to the logical address obtained based on the map loading unit loaded in step S630. The description thereof will be detailed with reference to FIG. 12.

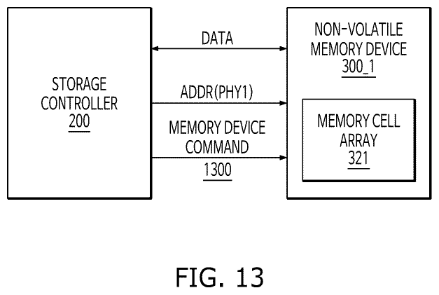

In step S670, the storage controller 200 may perform an operation according to a command based on the physical address determined in step S660. The description thereof will be detailed with reference to FIG. 13.

FIG. 7A is a view illustrated to explain step S610 of FIG. 6 according to an embodiment of the present disclosure. FIG. 7B is a view illustrated to explain step S610 of FIG. 6 according to another embodiment of the present disclosure.

Referring to FIG. 7A, the hint provider 223 (or a storage controller) may obtain one or more logical addresses 700 associated with one or more commands queued to the command queue 23 of the host memory 22 of the host device 20. For example, the hint provider 223 may transmit a request for performing the peeking to the host device 20 (or, the host controller 21), and the host device 20 (or the host controller 21) may transmit one or more logical addresses 700 to the hint provider 223 in response to the request from the hint provider 223.

One or more logical addresses 700 obtained by the hint provider 223 may include a first logical address associated with a first command CMD1, a second logical address associated with a second command CM2, and a third logical address associated with a third command CMD3, but the present disclosure is not limited thereto, and may include any number of logical addresses.

The hint provider 223 may obtain one or more logical addresses 700 through one request. For example, the hint provider 223 may transmit a request to the host device 20 (or, the host controller 21) by specifying a specific range of the command queue 23, and obtain one or more logical addresses 700 of one or more commands (e.g., CMD1, CMD2, and CMD3) stored within the range. The specific range of the command queue 23 may include a location for storing a command (e.g., CMD1) to be processed by the storage controller following a command currently being fetched from the command queue 23 or being processed by the storage controller after being fetched from the command queue 23. One or more commands within the specific range of the command queue 23 may be processed sequentially. For example, a second command CMD2 may be processed following a first command CMD1 by the storage controller, and a third command CMD3 may be processed following the second command CMD2.

The hint provider 223 may obtain one or more logical addresses 700 through one or more requests. For example, the hint provider 223 may designate a specific location of the command queue 23 to transmit a request to the host device 20 (or the host controller 21), obtain the logical address of the one command stored in the corresponding location, and obtain a plurality of logical addresses by repeating the above process. The one or more requests may include a request for obtaining a logical address associated with the command currently being fetched from the command queue 23 or the command fetched to be processed following the command being processed by the storage controller.

According to embodiments, the hint provider 223 may obtain the logical address (e.g., a start logic block address) and the number of logic blocks related to each command from the host device 20.

Referring to FIG. 7B, the hint provider 223 (or, a storage controller) may indirectly obtain one or more logical addresses 700 associated with one or more commands queued to the command queue 23 of the host memory 22. For example, the hint provider 223 may transmit a request for performing peeking to the host device 20 (or, the host controller 21), and the host device 20 (or, the host controller 21) may transmit an address 710 of the host memory 22 in which one or more logical addresses 700 are stored to the hint provider 223 in response to the request from the hint provider 223.

The hint provider 223 may obtain one or more logical addresses 700 associated with the command queued to the command queue 23 by performing a read operation on the address 710 of the host memory 22.

FIG. 8 is a view illustrated to explain steps S620 and S630 of FIG. 6 according to embodiments of the present disclosure.

The storage controller (e.g., 200 of FIG. 5A and FIG. 5B) may request a map loading unit corresponding to the logical address (e.g., 700 of FIG. 7) obtained in step S610 of FIG. 6 to the non-volatile memory device 300_1.

The hint provider 223 may transmit the logical address obtained in step S610 to the map loader 225.

According to embodiments, the hint provider 223 (or the host interface circuit 211 of FIG. 1) may generate a logical address list 810 including one or more logical addresses obtained in step S610 of FIG. 6, and transmit the generated logical address list 810 to the map loader 225 (or the flash translation layer 215 of FIG. 1). For example, the logical address list 810 may include a first logical address LOG1 associated with the first command CMD1 of FIGS. 7A and 7B, a second logical address LOG2 associated with the second command CMD2, and a third logical address LOG3 associated with the third command CMD3.

The map loader 225 (or the flash translation layer 215 of FIG. 1) may transmit a map loading request 820 to the non-volatile memory device 300_1 for requesting loading of at least one map loading unit 830 corresponding to one or more logical addresses included in the received logical address list 810 in response to receiving the logical address list 810.

According to embodiments, the map loading request 820 may include the logical address and (e.g., a start block logical address) and the number of logic blocks associated with a specific command. The hint provider 223 may generate the logical address list 810 based on the logical address and (e.g., a start block logical address) and the number of logic blocks associated with a specific command. For example, the logical address list 810 of FIG. 8 may be generated when the start block logical address is the first logical address LOG1, and the number of logic blocks is three (3). The map loader 225 may request at least one map loading unit corresponding to the logical address and (e.g., a start block logical address) and the number of logic blocks associated with a specific command from the non-volatile memory device 300_1.

According to embodiments, the non-volatile memory device 300_1 may transmit at least one map loading unit 830 to the volatile memory 230 in response to the map loading request 820 of the map loader 225 or the storage controller (e.g., 200 of FIG. 5b). For example, the at least one map loading unit 830 may include a first map loading unit MLU1 including a first physical address PHY1 corresponding to the first logical address LOG1, a second map loading unit MLU2 including a second physical address PHY2 corresponding to the second logical address LOG2, and a third map loading unit MLU3 including a third physical address PHY3 corresponding to the third logical address LOG3. According to another example, the non-volatile memory device 300_1 may select at least one map loading unit based on the logical address (e.g., a start block logical address) and the number of logic blocks associated with a specific command and transmit the at least one map loading unit to the volatile memory 230.

According to another embodiment, the non-volatile memory device 300_1 may transmit at least one map loading unit 830 to the storage controller (or, the volatile memory 230 of the storage controller) in response to the map loading request 820 of the map loader 225 or the storage controller (e.g., 200 of FIG. 5A).

FIG. 9 is a flowchart illustrating step S630 of FIG. 6 in detail according to exemplary embodiments of the present disclosure. FIG. 10A and FIG. 10B are views illustrated to explain a process where victim data 232_1, 232_2, and 232_3 are determined and overwritten.

Referring to FIG. 9 and FIG. 10A, the cache manager 226 may determine the victim data 232_1, 232_2, and 232_3 in step S632. In FIG. 10A, the victim data 232_1, 232_2, and 232_3 are illustrated as including three (3) map loading units, but the present disclosure is not limited thereto. For example, the number of map loading units included in the victim data 232_1, 232_2, and 232_3 may be determined based on the number of one or more map loading units 830 to be transferred from the non-volatile memory device 300_1 to the volatile memory 230.

The cache manager 226 may obtain a plurality of logical addresses associated with a plurality of commands queued to the command queue. For example, the cache manager 226 may receive the logical address list 810 from the hint provider 223.

The cache manager 226 may determine the victim data 232_1, 232_2, and 232_3 based on the logical address list 810 (or one or more logical addresses included in the logical address list 810) received from the hint provider 223.

According to embodiments, the cache manager 226 may determine a portion of data, excluding the map loading unit corresponding to one or more logical addresses in the logical address list 810 among the second set of map loading units 232, as the victim data 232_1, 232_2, and 232_3. When the map loading unit corresponding to one or more logical addresses in the logical address list 810 is stored in the volatile memory 230, unnecessary overwriting may be prevented by excluding the map loading unit from the victim data 232_1, 232_2, and 232_3.

According to embodiments, the cache manager 226 may determine a map loading unit with the lowest reference count among the second set of the map loading units 232 as the victim data 232_1, 232_2, and 232_3. When a plurality of map loading units are to be determined as the victim data 232_1, 232_2, and 232_3, the cache manager 226 may determine any number of map loading units in the order of increasing reference counts as the victim data 232_1, 232_2, and 232_3. The reference count may indicate the number of times each map loading unit of the second set of the map loading units 232 is to be referenced by a command. For example, referring to FIG. 7A, in response to the hint provider 223 obtaining one or more logical addresses 700, a reference count for the map loading unit 830 corresponding to the obtained one or more logical addresses 700 may be increased. In response to the completion of the processing of a specific command, the reference count for the map loading unit corresponding to the logical address associated with the command may be reduced. Therefore, unnecessary resource consumption that occurs by loading the map loading unit overwritten by another map loading unit into the volatile memory 230 may be minimized.

The cache manager 226 may determine the victim data 232_1, 232_2, and 232_3 based on information on at least one map loading unit in which a flush operation is to be performed among a plurality of logical addresses and the second set of map loading units 232. For example, the cache manager 226 may exclude the map loading unit in which the flush operation is to be performed from the victim data 232_1, 232_2, and 232_3. According to another example, when a plurality of map loading units with a minimum reference count among the second set of map loading units 232 are present, other map loading units excluding the map loading unit in which the flush operation is to be performed may be determined as the victim data 232_1, 232_2, and 232_3. Therefore, unnecessary resource consumption caused by performing a flush operation before overwriting the victim data 232_1, 232_2, and 232_3 may be minimized.

The cache manager 226 may transmit information 1010 on the determined victim data 232_1, 232_2, and 232_3 to the map loader 225.

The map loader 225 may transmit the map loading request 820 to the non-volatile memory device 300_1. The map loading request 820 transmitted by the map loader 225 may include the information 1010 on the victim data 232_1, 232_2, and 232_3. For example, the map loading request 820 may include the addresses of the victim data 232_1, 232_2, and 232_3.

In response to receiving the map loading request 820, the non-volatile memory device 300_1 may load or store one or more map loading units 830 into the volatile memory 230. For example, referring to FIG. 10B, the non-volatile memory device 300_1 may load or store one or more map loading units 830 into the volatile memory 230 by overwriting the victim data 232_1, 232_2, and 232_3 with one or more map loading units 830.

According to another embodiment, the non-volatile memory device 300_1 may transmit one or more map loading units 830 to the storage controller, and the storage controller may load and/or store one or more map loading units 830 in the volatile memory 230.

According to embodiments, one or more map loading units 830 may be loaded into the volatile memory 230 substantially simultaneously. According to another embodiment, one or more map loading units 830 may be loaded into the volatile memory 230 corresponding to the order of execution of the commands. For example, after the first map loading unit MLU1 is loaded, the second map loading unit MLU2 may be loaded following the first map loading unit MLU1, and after the second map loading unit MLU2 is loaded, the third map loading unit MLU3 may be loaded following the second map loading unit MLU2.

According to embodiments, one or more map loading units 830 may be loaded when a command is processed before one or more commands corresponding to one or more map loading units 830 are fetched or processed by a storage controller.

According to embodiments, the map loading unit corresponding to the logical address associated with a command may be loaded to the volatile memory 230 before the command is fetched. Therefore, the second set of the map loading unit 232 may be maintained with a smaller capacity than the first set of map loading unit (310 of FIG. 5) of the non-volatile memory device 300_1, and the map loading unit corresponding to the fetched command may be pre-loaded to the volatile memory 230. As a result, the latency that might occur by loading the map loading unit after fetching the command may be minimized.

FIG. 11 is a view illustrated to explain steps S640 and S650 according to embodiments of the present disclosure. FIG. 12 is a view illustrated to explain step S660 according to embodiments of the present disclosure.

Referring to FIG. 11, a command handler 221 may fetch a specific command from a command queue 23 (or a host device 20). For example, the command handler 221 may fetch a first command CMD1 from the command queue 23.

The command handler 221 may obtain a first logical address LOG1 associated with the first command CMD1 from the fetched first command CMD1. The command handler 221 may transmit the obtained first logical address LOG1 to a processor 222.

The processor 222 may process the first command CMD1 using the first logical address LOG1. For example, the processor 222 may transmit the first logical address LOG1 to the map accessor 224 and request the first physical address PHY1 corresponding to the first logical address LOG1 to the map accessor 224.

Referring to FIG. 11 and FIG. 12, in response to receiving the first logical address LOG1, the map accessor 224 may obtain a first map loading unit MLU1 corresponding to the first logical address LOG1 from the second set of map loading units 232 of the volatile memory 230. The first map loading unit MLU1 may be loaded into the volatile memory 230 prior to fetching the first command CMD1. The first map loading unit MLU1 may include the first logical address LOG1 and the first physical address PHY1 corresponding to the first logical address LOG1.

The map accessor 224 may obtain the first map loading unit MLU1 loaded into the volatile memory 230 and determine the first physical address PHY1 of a non-volatile memory device 300_1 corresponding to the first logical address LOG1 based on the obtained first map loading unit MLU1.

The map accessor 224 may transmit the determined first physical address PHY1 to the processor 222.

FIG. 13 is a view illustrated to explain step S670 of FIG. 6 according to embodiments of the present disclosure.

Referring to FIG. 12 and FIG. 13, the storage controller 200 may transmit and receive data DATA to and from the non-volatile memory device 300_1, and transmit a memory device command 1300 associated with an address ADDR including the first physical address PHY1 and the first command CMD1 of FIG. 12 to the non-volatile memory device 300_1. The memory device command 1300 may be a command that instructs the non-volatile memory device 300_1 to perform an operation associated with the command fetched from a host device (e.g., 20 of FIG. 1).

The nonvolatile memory device 300_1 may perform the operation requested by the storage controller 200 based on the first physical address PHY1 and the memory device command 1300 received from the storage controller 200. For example, the first command CMD1 of FIG. 12 may be a read command, a write command, or a TRIM command, and the control logic circuit (e.g., 323 of FIG. 2) of the non-volatile memory device 300_1 may perform a read operation, a write operation, or a TRIM operation for a specific location of the memory cell array 321 based on the received memory device command 1300 (e.g., CMD of FIG. 2).

The present disclosure is not limited to the above-described embodiments and the attached drawings, and substitution, modification, and change to the embodiments are possible by those skilled in the art without departing from the technical spirit of the present disclosure, which also falls within the scope of the present disclosure. For example, one or more steps of the process with reference to the flowcharts in drawings may be omitted, the order of each step may be changed, one or more steps may be performed with temporal overlap or one or more steps may be repeatedly performed multiple times.

What is claimed is:

1. A storage device, comprising:
a non-volatile memory device configured to store a first set of a map loading unit to convert a logical address into a physical address; and
a storage controller configured to store a second set of a map loading unit in a volatile memory based on the first set of the map loading unit,
wherein the storage controller is further configured to:
based on a first command received from a host device, load a first map loading unit corresponding to the first command of the first set of the map loading unit from the non-volatile memory device;
store the first map loading unit in the volatile memory;
obtain a first logical address associated with a second command queued to a command queue of the host device;
load a second map loading unit of the first set of the map loading unit, corresponding to the obtained first logical address, from the non-volatile memory device; and
store the second map loading unit in the volatile memory.

2. The storage device as claimed in claim 1, wherein the storage controller is further configured to, after loading the second map loading unit to the volatile memory:
fetch the second command from the host device;
obtain the first logical address from the fetched second command;
determine a physical address of the non-volatile memory device corresponding to the first logical address, based on the second map loading unit stored in the volatile memory; and
transmit a memory device command instructing the non-volatile memory device to perform an operation associated with the second command, and the physical address, to the non-volatile memory device.

3. The storage device as claimed in claim 1, wherein the second command is a command to be processed by the storage controller following the first command being fetched from the host device.

4. The storage device as claimed in claim 1,
wherein the storage controller is further configured to:
obtain a second logical address associated with a third command queued to the command queue;
load, from the non-volatile memory device, a third map loading unit corresponding to the obtained second logical address of the first set of the map loading unit; and
store the third map loading unit in the volatile memory device, and
wherein the third command is a command to be processed by the storage controller following the second command.

5. The storage device as claimed in claim 4, wherein the storage controller is further configured to store the second map loading unit in the volatile memory and then store the third map loading unit in a sequence following the second map loading unit in the volatile memory.

6. The storage device as claimed in claim 1, wherein the storage controller is further configured to:
obtain, from the host device, a number of logic blocks associated with the second command;
load, from the non-volatile memory device, among the first set of the map loading unit, at least one map loading unit corresponding to the first logical address and the number of logic blocks and including the second map loading unit; and
store the at least one map loading unit in the volatile memory.

7. The storage device as claimed in claim 1,
wherein the first set of the map loading unit comprises the second set of the map loading unit, and
wherein a size of the second set of the map loading unit is smaller than a size of the first set of the map loading unit.

8. The storage device as claimed in claim 1, wherein the first set of the map loading unit comprises a plurality of logical addresses corresponding to a total number of logic blocks and a plurality of physical addresses corresponding to the plurality of logical addresses.

9. The storage device as claimed in claim 1, wherein the storage controller is further configured to, overwrite victim data that is a part of the second set of the map loading unit, with the second map loading unit to store the second map loading unit in the volatile memory.

10. The storage device as claimed in claim 9, wherein the storage controller is further configured to:
obtain a plurality of logical addresses associated with a plurality of commands queued to the command queue, the plurality of logical addresses including the first logical address;
determine the victim data based on the plurality of logical addresses; and
overwrite the determined victim data with the second map loading unit to store the second map loading unit in the volatile memory.

11. The storage device as claimed in claim 10, wherein the storage controller is further configured to determine a part of data excluding a map loading unit corresponding to the plurality of logical addresses from the second set of the map loading unit as the victim data.

12. The storage device as claimed in claim 10, wherein the storage controller is further configured to:
increase a reference count for a map loading unit of the second set of the map loading unit, corresponding to the plurality of logical addresses; and
determine a map loading unit of the second set of the map loading unit with a lowest reference count, as the victim data.

13. The storage device as claimed in claim 9, wherein the storage controller is further configured to:
obtain a plurality of logical addresses associated with a plurality of commands queued to the command queue, the plurality of logical addresses including the first logical address;
determine the victim data, based on the plurality of logical addresses and information on at least one map loading unit of the second set of the map loading unit in which a flush operation is performed; and
overwrite the determined victim data with the second map loading unit and store the second map loading unit in the volatile memory.

14. The storage device as claimed in claim 1, wherein the first command is a read command, a write command, or a TRIM command.

15. A storage controller, comprising:
a host interface circuit configured to receive a first command from a host device, and obtain a first logical address associated with a second command queued to a command queue of the host device, and a second logical address associated with a third command queued to the command queue; and
a flash translation layer configured to load, from a non-volatile memory device, a first map loading unit corresponding to the first command, a second map loading unit corresponding to the first logical address and a third map loading unit corresponding to the second logical address, and store, in a volatile memory, the first map loading unit, the second map loading unit and the third map loading unit; and
one or more processors,
wherein the second command and the third command are commands to be processed by the one or more processors in a sequence following the first command.

16. The storage controller as claimed in claim 15,
wherein the third command is a command to be processed by the one or more processors in sequence following the second command,
wherein the host interface circuit is further configured to:
fetch the second command and the third command from the host device after the flash translation layer stores the second map loading unit and the third map loading unit in the volatile memory; and
obtain the first logical address and the second logical address from the fetched second command and third command,
wherein the flash translation layer is further configured to obtain, from the loaded second map loading unit and third map loading unit, a first physical address and a second physical address of the non-volatile memory device corresponding to the first logical address and the second logical address, and
wherein the one or more processors are configured to transmit a first memory device command associated with the second command, a second memory device command associated with the third command, the first physical address and the second physical address, to the non-volatile memory device.

17. The storage controller as claimed in claim 15,
wherein the host interface circuit is further configured to obtain the first logical address and the second logical address while fetching the first command from the host device, and
wherein the second command and the third command are commands to be processed by the one or more processors in sequence following the first command.

18. The storage controller as claimed in claim 15,
wherein the host interface circuit is further configured to:
generate a list including the first logical address and the second logical address; and
transmit the generated list to the flash translation layer, and
wherein the flash translation layer is further configured to:
receive the list;
in response to receiving the list, request, to the non-volatile memory device, the second map loading unit and the third map loading unit corresponding to the first logical address and the second logical address included in the received list; and
store the second map loading unit and the third map loading unit corresponding to the first logical address and the second logical address in the volatile memory.

19. A storage system, comprising:
a host device comprising a host memory comprising a command queue;
a non-volatile memory device configured to store a first set of a map loading unit for converting a logical address into a physical address; and
a storage controller configured to store a second set of a map loading unit in a volatile memory based on the first set of the map loading unit,
wherein the storage controller is further configured to:
based on a first command received from the host device, load a first map loading unit corresponding to the first command of the first set of the map loading unit from the non-volatile memory device;
store the first map loading unit in the volatile memory;
obtain a logical address associated with a second command queued to a command queue of the host device;
load a second map loading unit of the first set of the map loading unit, corresponding to the obtained logical address associated with the second command, from the non-volatile memory device; and
store the second map loading unit in the volatile memory.

20. The storage system as claimed in claim 19, wherein the storage controller is further configured to:
obtain an address of the host memory in which a logical address associated with the second command is stored; and
obtain the logical address associated with the second command queued to the command queue by performing a read operation on the obtained address.
